(19) United States
(12) Patent Application Publication
(10) Pub. No.: US 2022/0203820 A1
(43) Pub. Date: Jun. 30, 2022

(54) Transmission Arrangement for a Motor Vehicle and Motor Vehicle

(71) Applicant: ZF Friedrichshafen AG, Friedrichshafen (DE)

(72) Inventors: Fabian Kutter, Kressbronn (DE); Johannes Kaltenbach, Friedrichshafen (DE); Matthias Horn, Tettnang (DE); Uwe Griesmeier, Markdorf (DE); Stefan Beck, Eriskirch (DE); Thomas Martin, Weissensberg (DE)

(21) Appl. No.: 17/605,649

(22) PCT Filed: Mar. 4, 2020
(86) PCT No.: PCT/EP2020/055626

§ 371 Date: Oct. 22, 2021

(30) Foreign Application Priority Data
Apr. 23, 2019 (DE) 10 2019 205 763.2

(51) Int. Cl. B60K 6/405; B60K 6/547; B60K 6/365

(52) U.S. Cl. CPC B60K 6/405; B60K 6/365; B60K 6/547

(57) ABSTRACT

A transmission arrangement (10) for a motor vehicle includes a housing. The housing delimits an interior space and includes an intermediate housing wall (14), which subdivides the interior space into a first subspace and a second subspace (16). At least one electric machine is arranged in the first subspace, and a transmission (20) is at least partially arranged in the second subspace (16). An output shaft of the transmission (20) is connected to a differential (24) of the motor vehicle. At least one power terminal (26) is connected to the electric machine and is routed through respective passage openings in the intermediate housing wall (14) from the first subspace into the second subspace (16) of the interior space. The passage openings are arranged in an area of the intermediate housing wall (14) that is situated on a side of an orthogonal line (32) facing away from the differential (24) relative to a straight line (36) between a main axis (22) of the transmission and a main axis (38) of the differential (24).

### CROSS-REFERENCE TO RELATED APPLICATIONS

The present application is related and has right of priority to German Patent Application No. 102019205763.2 filed in the German Patent Office on Apr. 23, 2019 and is a nationalization of PCT/EP2020/055626 filed in the European Patent Office on Mar. 4, 2020, both of which are incorporated by reference in their entirety for all purposes.

### FIELD OF THE INVENTION

The present application relates generally to a transmission arrangement for a motor vehicle and to a motor vehicle.

### BACKGROUND

Motor vehicles can have more than one engine or motor. In particular, the combination of at least one electric motor and one internal combustion engine can be advantageous with regard to consumption, environmental protection, and power. For this purpose, however, both the electric motor and the internal combustion engine must be integrated into the drive train of the motor vehicle for the transmission of the particular input power onto the vehicle wheels. For good efficiency, it is advantageous when this integration can also provide various gear stages. For this purpose, a transmission arrangement of a motor vehicle can include at least one transmission, by which the electric motor and the internal combustion engine are connected or are connectable to a drive axle for the transmission of torque.

In principle, an electric motor must also be supplied with electrical energy. A power electronics unit is usually provided for this purpose, which controls, by way of an open-loop system, the current flow to the motor and, thereby, the power output. An electric machine or an electric motor can also be designed for generating current, for example, when the electric machine or the electric motor is utilized for decelerating. This generated current can also be output via the power terminals, for example, to a main power circuit of the motor vehicle and/or a power store such as a rechargeable battery.

For protection, an electric machine, which can also be referred to as an electric motor or an e-machine, is usually arranged in a closed housing. In the case of a design for high power, the electric machine can be oil-cooled, which is also made possible by a closed housing. The power electronics unit is usually arranged outside the housing, however. Therefore, particular power terminals must be routed out of the housing.

DE 10 2013 021 581 describes, for example, a starter generator with a housing, wherein a connecting element is also provided.

### SUMMARY OF THE INVENTION

Example aspects of the present application provide an improved transmission arrangement for a motor vehicle.

A first example aspect relates to a transmission arrangement for a motor vehicle with a housing, which delimits an interior space. In addition, the transmission arrangement includes an intermediate housing wall, which subdivides the interior space into a first subspace and a second subspace. The first subspace can also be referred to as a first subarea and the second subspace can also be referred to as a second subarea, in particular as a subarea of the interior space. The intermediate housing wall is therefore arranged within the interior space and preferably extends from one inner side to an opposite inner side. The intermediate housing wall can also be referred to as an inner wall. The housing can also be referred to as a transmission housing and/or a drive housing. The housing can have a housing part, for example, for each subspace, which are connected to each other to form the housing and the interior space.

At least one electric machine can be arranged in the first subspace and a transmission can be at least partially arranged in the second subspace, by which the electric machine is connectable to an output shaft of the transmission for transmitting torque. The output shaft can be connected to a differential of the motor vehicle. The electric machine can be designed as a starter, a starter generator, a generator, and/or preferably as an electric drive of the motor vehicle. The transmission can provide multiple gear stages or ratios for the electric machine, which can also be referred to as gears. For this purpose, the transmission can include, for example, one or multiple planetary gear set(s), which can also be referred to as a planetary transmission or planetary transmissions. In addition, the transmission can include at least one clutch, by which the electric machine can be connected to or disconnected from the differential.

The transmission arrangement can also include an internal combustion engine, which can be arranged, for example, on a side of the transmission opposite the electric machine. In particular, in this way, the transmission arrangement can provide a hybrid drive. In this case, the transmission arrangement can be designed for being able to set different gear stages or gears for the electric machine and the internal combustion engine separately. A separate coupling and decoupling can also be provided. The internal combustion engine can also be arranged in the housing or also have a separate housing.

The transmission arrangement can also include at least one power terminal connected to the electric machine. Preferably, more than one power terminal is provided, and therefore the plurality will be assumed in the following for the sake of simplicity. Particular features and properties apply similarly for only one power terminal, however, provided that multiple power terminals are not explicitly necessary. The power terminals are preferably designed for transmitting electrical energy for operating the electric machine. Alternatively or additionally, the power terminals can also transmit electrical energy generated by the electric machine. Additionally or alternatively to the power transmission, particular control and/or sensor signals can also be transmitted. The power terminals can therefore be designed for the power supply and/or the open-loop control of the electric machine.

The power terminals can be routed through particular passage openings in the intermediate housing wall from the first subspace into the second subspace of the interior space. As a result, at least no passage is necessary from the first subspace toward the outside of the housing, which should then be sealed to protect the electric machine and to enable an oil cooling. Nevertheless, an oil supply of the first subspace can take place independently of the second subspace. For example, a separate amount of oil can be provided for the transmission than is provided for the electric machine. Minimal leakages are not disadvantageous here, in particular when a homogeneous oil is utilized, since the leakages then nevertheless remain in the particular other subspace of the interior space and do not reach the outside. The passage openings in the intermediate housing wall therefore preferably do not lead to the outside of the interior space.

The particular passage openings can be arranged in an area of the intermediate housing wall that is situated on a side of an orthogonal line—with respect to a straight line between a main axis of the transmission and a main axis of the differential—facing away from the differential. In this way, an area is defined, in which particular passage openings are advantageously arranged in the intermediate housing wall. The main axis can be considered to be, for example, an axis of rotation of the transmission, in particular a central axis of a planetary gear set. In the case of multiple planetary gear sets, the main axis can be defined by a common central axis of all planetary gear sets. The main axis of the differential can correspond, in particular, to the axis of rotation of the output shaft of the differential. The main axis of the differential can be coaxial to a drive axle of the motor vehicle or at least parallel thereto. The arrangement of the power terminals in the above-defined area is advantageous, in particular, in a transmission arrangement having a front-mounted transverse arrangement with a coaxially arranged, wheel-side electric traction machine as the electric machine. The power terminals are therefore routed here axially through the intermediate housing wall in the direction of the transmission and the machine toward the outside without an opening.

By comparison, an arrangement axially in the direction of the wheel or the side of the housing facing away from the transmission is unfavorable with respect to the available installation space. In addition, the passage can then be in a spray area of the electric machine and the passage would lead toward the outside, which could then make a seal necessary. A radial passage in the area of the electric machine toward the outside can also require a complex seal or weaken the shielding of the electric machine with respect to environmental influences. A passage axially toward the outside in the direction of the transmission is vulnerable to damage in the case of minimal position deviations due to the small amount of installation space available there and due to particular moveable parts of the transmission. A passage axially toward the outside in a machine-side wall of the housing also requires a long cable routing. The above-described problems do not occur in the preferred area for the passage openings for the power terminals or only to a lesser extent.

The area for the passage openings is established in such a way that the passage openings do not come into conflict with the installation space for the intermediate shaft, the differential, a potential second axially parallel electric machine and/or one or multiple shift rail(s) and/or selector fork(s). In addition, the position at the circumference can be selected in such a way that a cable length to the power electronics unit becomes particularly short. The position of the power electronics unit can differ depending on the vehicle installation space and customer requirements, wherein, due to the area, a very broad spectrum of positions can be advantageously covered. Due to the selected area and passage openings in the intermediate housing wall, the cable routing can take place within the housing, in particular within the transmission housing, to the power electronics unit, which can include an inverter. No housing openings toward the outside are necessary at least in the first subarea and, thereby, no re-working of the housing is necessary. In the second subarea of the housing, openings are usually already necessary for the mechanical adjustment of the transmission and/or of the gears, and so sealing and openings are usually already necessary here. The amount of additional effort required for a passage toward the outside can therefore be less here. Particular connectors and/or screw connections for the power terminals can therefore be less expensively designed. In addition, the cable routing in the housing can be very short, while, simultaneously, no cable routing is necessary outside the housing. As a result, particular cables can be particularly well protected and additional mountings and/or coverings can be dispensed with. Overall, in this way, for example, also only one sealing point can be necessary in order to route the power terminals from the electric machine to the power electronics unit. Due to the selected area, in addition, an axially compact design can be achieved, since an axial spacing to adjacent transmission parts is possibly not necessary.

In one further example embodiment of the transmission arrangement, it is provided that the transmission arrangement is designed, in particular, for a transverse installation in the motor vehicle, in particular a front-mounted transverse arrangement. The selected area for the passage openings in the intermediate housing wall is particularly advantageous here. In a transverse arrangement, a main extension of the transmission arrangement can be essentially parallel to a transverse direction of the motor vehicle. The main extension can be defined by particular main axes of the transmission, of the electric machine and/or of the internal combustion engine, and/or can be parallel thereto.

In one further example embodiment of the transmission arrangement, it is provided that the transmission arrangement includes an intermediate shaft, by which the output shaft of the transmission is connected to the differential for the transmission of torque and the orthogonal line is situated on the axis of rotation of the intermediate shaft or intersects the intermediate shaft. As a result, particular passage openings in the intermediate housing wall are situated outside of an installation space area competing with the intermediate shaft. As a result, the transmission arrangement can be particularly compact, in particular axially compact. In addition, the assembly and maintenance are particularly simple in this way, since the intermediate shaft is then not in the way, or is hardly in the way, of the assembly and maintenance. The intermediate shaft is utilized, for example, for enabling an axial offset of the drive axle and/or the differential with respect to the output shaft of the transmission. As a result, the internal combustion engine, the electric machine, and/or the transmission itself can be arranged essentially on a straight line, for example, with respective centroids or main axes, as the result of which the transmission arrangement can be compact and particularly suitable for a transverse arrangement in the motor vehicle.

In one further example embodiment of the transmission arrangement, it is provided that the particular passage openings are arranged in a radially outer area of the intermediate housing wall. In particular, this can be a radially outermost area, which, however, is preferably spaced apart from the outer wall of the housing. More installation space is usually available in the outer area, in particular due to shafts and/or gearwheels of the transmission not extending completely radially up to the edge.

In one further example embodiment of the transmission arrangement, it is provided that the particular passage openings are arranged radially within an outer stator diameter of the electric machine. As a result, a structural weakening of particular outer housing walls can be avoided. The transmission arrangement can therefore also be radially compact, since the stator usually has a larger diameter than the transmission.

In one further example embodiment of the transmission arrangement, it is provided that the particular passage openings are arranged, in an installation position of the transmission arrangement in the motor vehicle, in a vertically uppermost area of the intermediate housing wall. Due to other limitations of the area, the uppermost area cannot correspond to the vertically uppermost end area of the housing. A vertically uppermost area is advantageous with regard to a complexity of an oil seal. In addition, the power electronics unit is frequently also arranged in an upper area, as the result of which the cable routing can be short. The alignment of the transmission arrangement is apparent, for example, at an oil pan and/or due to the fact that the intermediate shaft is usually arranged at the bottom and/or the differential is arranged below the transmission. The alignment can therefore be identified regardless of the actual installation at the motor vehicle.

In one further example embodiment of the transmission arrangement, it is provided that the transmission arrangement includes a power electronics unit, in particular an inverter, which is connected to the electric machine by the particular power terminals. Preferably, the power electronics unit is arranged adjacent to the passage openings on the outside of the housing and/or the transmission, in particular on the outside of the second subspace. Particular power terminals are preferably routed to the power electronics unit through passage openings in the housing, which connect the second subspace of the interior space to an outer side of the housing. These passage openings can be sealed, wherein the complexity can be less here than in the first subspace of the housing.

In one further example embodiment of the transmission arrangement, it is provided that the transmission arrangement includes a power electronics housing, which is sealingly arranged on the outside of the housing. In particular, the power electronics housing can be arranged in the circumferential area of the housing adjacent to the passage openings for a short cable routing. The power electronics housing may be designed, for example, in the manner of a hood or a cover having an opening facing the housing. Preferably, a sealing point is provided at a connection between the power electronics housing and the rest of the housing of the transmission arrangement. A seal of the particular passage openings toward the outside in the second subspace of the housing can then be dispensed with. Usually, the power electronics housing is to be sealed in order to protect the electronics against moisture. As a result, the transmission arrangement can be particularly low-cost. It is therefore possible to dispense with a seal of particular passage openings from the second subspace of the interior space toward the outside and/or particular passage openings through the outer housing wall, through which power terminals are routed.

In one further example embodiment of the transmission arrangement, it is provided that particular passage openings in an outer wall of the housing, through which the power terminals are routed from the second subspace of the interior space toward the outside of the interior space of the housing, extend in an interior space of a power electronics unit delimited by the power electronics housing and an outer side of the housing. The passage opening from the interior area of the housing then therefore extends practically from one interior space into another interior space. Sealing off the two interior spaces from one another can be dispensed with here.

In one further example embodiment of the transmission arrangement, it is provided that the transmission includes at least one planetary gear set. With one planetary gear set, the transmission can be particularly compact and/or provide particularly high ratios. The planetary gear set can define the main axis of the transmission by the axis of rotation of the planetary gear set. The planetary gear set can also be referred to as a planetary transmission. The planetary gear set usually includes a planet carrier having one or multiple planet gear(s), a sun gear, and a ring gear. Preferably, the transmission includes at least two planetary gear sets, which can be connected to each other depending on the selected gear, in particular arranged coaxially and axially next to one another.

In one further example embodiment of the transmission arrangement, it is provided that one passage opening for each power terminal is provided in the intermediate housing wall and/or in the outer housing wall. As a result, the cable routing can be facilitated.

Alternatively, in one further example embodiment of the transmission arrangement, it can be provided that one common passage opening for all power terminals is provided in the intermediate housing wall and/or in the outer housing wall. As a result, a sealing can require little effort and/or the production of the necessary passage openings for the power terminals is particularly low-cost and simple.

In one further example embodiment of the transmission arrangement, it is provided that particular power terminals are designed as a metallic rail at least in the passage opening area of the intermediate housing wall. As a result, the assembly and also the connection to the electric machine is facilitated.

In one further example embodiment of the transmission arrangement, it is provided that the area for the arrangement of the particular passage openings in the intermediate housing wall has no axial overlap with a second electric machine, which is axially parallel to the electric machine, with particular actuators of the transmission, particular shift rails of the transmission, and/or particular selector forks of the transmission. The actuators can be, in particular, actuators for moving the shift rails and/or selector forks. The area is therefore preferably situated radially outside the radial extension of these parts. As a result, the transmission arrangement can be particularly compact and nevertheless simple to assemble.

A second example aspect relates to a motor vehicle including a transmission arrangement according to the first example aspect. The features and advantages resulting from the transmission arrangement according to the first example aspect are to be derived from the descriptions of the first example aspect, wherein example embodiments of the first example aspect are to be considered to be example embodiments of the second example aspect, and vice versa.

Preferably, the transmission arrangement is arranged in a front-transverse alignment in the motor vehicle. The motor vehicle can preferably have a drive installed transversely at its front side.

Further features result from the claims, the exemplary embodiment, and on the basis of the drawings. The features and combinations of features mentioned above in the description as well as the features and combinations of features mentioned in the following in the exemplary embodiments are usable not only in the particular described combination, but rather also in other combinations, without departing from the scope.

### BRIEF DESCRIPTION OF THE DRAWINGS

FIG. 1 illustrates, in a diagrammatic side view, an example transmission arrangement having power terminals for an electric machine.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

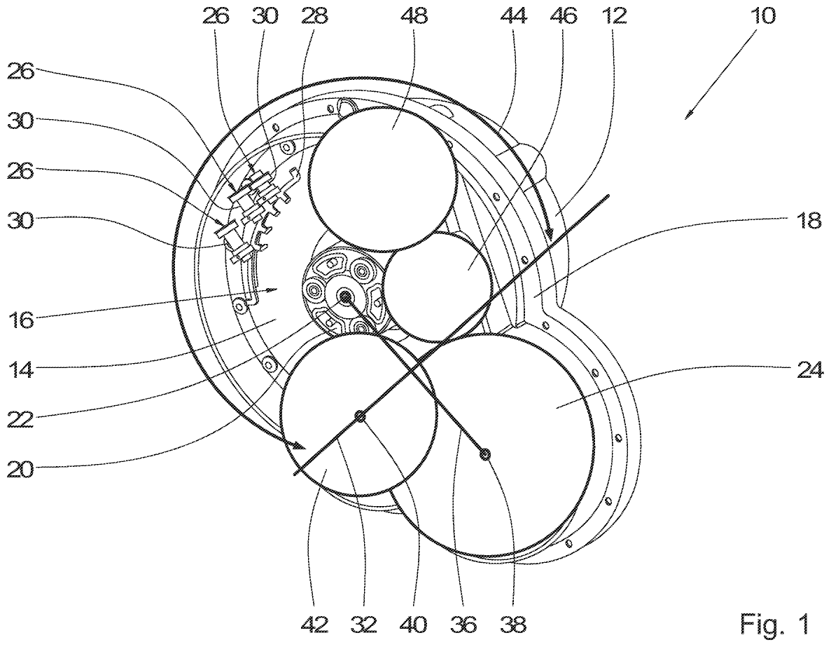

FIG. 1 shows a portion of a transmission arrangement 10 for a motor vehicle including a housing, wherein only one housing part 12 of the housing, which is designed for accommodating an electric machine, is represented. The electric machine is accommodated in a first subspace of an interior space of the housing, which is covered by the housing part 12 in FIG. 1. The housing has an intermediate housing wall 14, which can be part of the housing part 12 or also a separate part. This intermediate housing wall 14 divides an interior space delimited by the housing into the first subspace and a second subspace 16, which faces the observer in FIG. 1. The interior space and, in particular, the second subspace 16 can be closed by a second housing part (not shown), which can be connected to the first housing part. The second housing part abuts, for example, a collar 18 of the housing part 12 and is bolted together therewith.

In addition, the transmission arrangement 10 includes a transmission 20, which is partially shown in FIG. 1. The transmission 20 includes, for example, two planetary gear sets, which are arranged next to each other coaxially to an axis of rotation 22. The transmission 20 is accommodated, for example, completely in the first subarea in the interior space of the housing and is connected through the intermediate housing wall 14 to the electric machine for the transmission of torque. The electric machine can also be coaxial to the axis of rotation 22. In addition, the transmission arrangement 10 can also include an internal combustion engine, the output shaft of which is connected to the transmission 20 for transmitting torque and is coaxial to the axis of rotation 22. The internal combustion engine can be arranged, for example, along the axis of rotation 22 in the direction of the observer of FIG. 1.

The axis of rotation 22 corresponds to a main axis of the transmission 20 and the axial extension of the transmission arrangement 10. The intermediate housing wall 14 preferably extends radially and orthogonally with respect to the axis of rotation 22, although the intermediate housing wall 14 can also be slanted with respect to the axis of rotation 22. The intermediate housing wall 14 divides the interior space into the first subspace and the second subspace 16 in such a way that the transmission 20 and the electric machine can be supplied with different amounts of oil.

The transmission 20 can provide selectable gears having different transmission ratios for the electric machine as well as for the internal combustion engine independently of one another. The transmission 20 includes an output shaft, which is not represented in FIG. 1. This output shaft is connected to a differential 24 in order to transfer particular drive forces generated by the electric machine and/or the internal combustion engine to driven wheels of the motor vehicle.

The differential 24 is arranged at the bottom in the transmission arrangement 10. The alignment of the transmission arrangement 10 in FIG. 1 essentially corresponds to the actual installation position, wherein the axis of rotation 22 is essentially aligned in the vehicle transverse direction, in particular in parallel to a front axle of the motor vehicle. Preferably, the transmission arrangement is arranged at the front in the motor vehicle. The upward direction in FIG. 1 essentially corresponds, in the installation position, to a vertical direction and/or upward.

The electric machine is electrically connected to a power electronics unit (which is also not shown) by particular power terminals 26. A metallic rail 28 is represented, which is routed through particular passage openings in the intermediate housing wall 14 to the electric machine. Due to the passage openings in the intermediate housing wall 14, an opening to the outer side of the housing and/or through an outer wall of the first housing part 12 is not necessary. The passage openings therefore do not need to be sealed, since a minimal exchange of oil between the first subspace and the second subspace at these passage openings is not disadvantageous.

The power terminals 26 also have an L-shaped angle piece 30, which enables the cable routing upward toward the outer side of the housing. The power terminals 26 are routed through a connecting area between the first housing part 12 and the second housing part. A hood-shaped power electronics housing can be arranged around the mouth area, which closes off with the housing and in the interior space of which the power electronics unit is arranged. A certain oil exchange is also permissible here, and so the passage of the power terminals 26 toward the outside of the interior space does not need to be sealed. Instead, a seal can be provided between the power electronics housing and the housing, which simultaneously protects the power electronics unit. As a result, the transmission arrangement 10 is particularly simple and low-cost. The length of the cable routing of the power terminals 26 is also particularly short due to this position of the power electronics housing.

In order to achieve these advantages and, simultaneously, a compact transmission arrangement 10, the passage openings are to be arranged in a certain area of the intermediate housing wall 14. The area should be in a radially outer area of the intermediate housing wall 14, in order to be able to utilize the smallest and shortest angle pieces 30 possible and to not adversely affect the installation space of other parts.

In addition, the particular passage openings are arranged in an area of the intermediate housing wall 14 that is situated on a side of an orthogonal line 32—with respect to a straight line 36 between the main axis and/or the axis of rotation 22 of the transmission 20 and a main axis 38 of the differential 24—facing away from the differential 24. The main axis 38 of the differential 24 corresponds to the axis of rotation of the output shaft of the differential 24.

Advantageously, the orthogonal line intersects an axis of rotation 40 of an intermediate shaft 42 of the transmission 20. The intermediate shaft 40 bridges the axial offset between the transmission 20 and the differential 24.

This yields an advantageous area for the arrangement of the passage openings in the intermediate housing wall 14, which is illustrated by the double arrow 44.

The radial extension of the differential 24 and of the intermediate shaft 42 are also illustrated in FIG. 1. The differential 24 as well as the intermediate shaft 42 are arranged in a lower area of the interior space of the housing, which, in the present case, is integrally formed by the first housing part 12 in a lower protrusion. Alternatively, these two portions can also be arranged in separate housing parts and/or at least partially separated inner areas.

The transmission 20 also includes a shift rail 46, the radial installation space requirement of which, close to the intermediate housing wall, is illustrated in FIG. 1. In addition, the transmission arrangement can also include a second electric machine 48, which is axially parallel to the above-described electric machine, the radial installation space requirement of which is also illustrated. The passage openings for the power terminals 26 should not also be arranged in axial overlap with the shift rail 46 and the second electric machine 48, since the assembly can become difficult and/or an axial length of the transmission arrangement 10 can become greater otherwise. The passage openings for the power terminals 26 are therefore not to be arranged in the area of the intermediate housing wall 14 that is concealed in FIG. 1 by the representation of the shift rail 46 and the second electric machine 48.

Advantageously, the passage openings for the power terminals 26 are arranged in a vertically upper area of the intermediate housing wall 14. As a result, the power electronics unit can be arranged in the proximity and particular cable lengths are short. In addition, a seal is simple in this way, since the vertically upper area is usually exposed to only minimal amounts of oil spray.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 transmission arrangement
12 first housing part
14 intermediate housing wall
16 second subspace
18 collar
20 transmission
22 axis of rotation
24 differential
26 power terminals
28 rail
30 angle piece
32 orthogonal line
36 straight line
38 axis of rotation
40 axis of rotation
42 intermediate shaft
44 double arrow
46 shift rail
48 second electric machine

1-15. (canceled)

16. A transmission arrangement (10) for a motor vehicle, comprising:
a housing that delimits an interior space and includes an intermediate housing wall (14), which subdivides the interior space into a first subspace and a second subspace (16);
at least one electric machine arranged in the first subspace;
a transmission (20) at least partially arranged in the second subspace (16), the electric machine connectable to an output shaft by the transmission (20) for transmission of torque, the output shaft connected to a differential (24) of the motor vehicle; and
at least one power terminal (26) connected to the electric machine, the at least one power terminal (26) routed through one or more passage openings in the intermediate housing wall (14) from the first subspace into the second subspace (16) of the interior space,
wherein the passage openings are arranged in an area of the intermediate housing wall (14) that is situated on a side of an orthogonal line (32) facing away from the differential (24) relative to a straight line (36) between a main axis (22) of the transmission and a main axis (38) of the differential (24).

17. The transmission arrangement (10) of claim 16, wherein the transmission arrangement (10) configured for a front-mounted transverse installation.

18. The transmission arrangement (10) of claim 16, further comprising an intermediate shaft (42), the output shaft connected to the differential (24) by the intermediate shaft (42) for the transmission of torque, the orthogonal line (32) extending through an axis of rotation (40) of the intermediate shaft (42).

19. The transmission arrangement (10) of claim 16, wherein the passage openings are arranged in a radially outer area of the intermediate housing wall (14).

20. The transmission arrangement (10) of claim 16, wherein the passage openings are arranged radially within an outer stator diameter of the electric machine.

21. The transmission arrangement (10) of claim 16, wherein the passage openings, in an installation position of the transmission arrangement (10) in the motor vehicle, are arranged in a vertically uppermost area of the intermediate housing wall (14).

22. The transmission arrangement (10) of claim 16, further comprising a power electronics unit connected to the electric machine by the power terminals (26), the power electronics unit comprising an inverter.

23. The transmission arrangement (10) of claim 22, further comprising a power electronics housing sealingly arranged on an outside of the housing.

24. The transmission arrangement (10) of claim 23, wherein additional passage openings in an outer wall of the housing extend in an interior space of the power electronics unit, the interior space of the power electronics unit delimited by the power electronics housing and an outer side of the housing, the power terminals (26) routed from the second subspace (16) of the interior space toward the outside of the interior space of the housing through the additional passage openings.

25. The transmission arrangement (10) of claim 16, wherein the transmission (20) comprises at least one planetary gear set.

26. The transmission arrangement (10) of claim 16, wherein one or both of:
a respective passage opening for each power terminal (26) is provided in one or both of the intermediate housing wall (14) and in the outer housing wall; and
a single, common passage opening for the power terminals (26) is provided in one or both of the intermediate housing wall (14) and in the outer housing wall.

27. The transmission arrangement (10) of claim 16, wherein one or more of the power terminals (26) is configured as a metallic rail at least disposed in the passage opening area of the intermediate housing wall (14).

28. The transmission arrangement (10) of claim 16, wherein the passage opening area of the intermediate housing wall (14) does not overlap axially with a second electric machine (48) that is arranged axially parallel to the electric machine.

29. The transmission arrangement (10) of claim 16, wherein the passage opening area of the intermediate housing wall (14) does not overlap axially with one or more of an actuator, a shift rail (46), and a selector fork of the transmission.

30. A motor vehicle, comprising the transmission arrangement (10) of claim 16.
